(19) United States
(12) Patent Application Publication
(10) Pub. No.: US 2010/0274733 A1
(43) Pub. Date: Oct. 28, 2010

(54) METHOD AND SYSTEM FOR ENHANCED TAXONOMY GENERATION

(76) Inventors: Walter Engel, Healdsburg, CA (US); Campbell Pryde, New York, NY (US); Paul Sappington, Gaithersburg, MD (US)

Correspondence Address: ARENT FOX LLP, 1050 CONNECTICUT AVENUE, N.W., SUITE 400, WASHINGTON, DC, 20036, US

(21) Appl. No.: 12/766,795

(22) Filed: Apr. 23, 2010

Related U.S. Application Data
(60) Provisional application No. 61/172,183, filed on Apr. 23, 2009.

(51) Int. Cl. G06Q 10/00

(52) U.S. Cl. 705/348

(57) ABSTRACT

Methods and systems to automate the taxonomy generation process and allow for automatic synchronized cross-industry taxonomy updates. A standardized cross-industry taxonomy generation procedure is provided, which is easy to use and allows for fast generation of taxonomies. The errors in taxonomy generation are reduced, while producing synchronized industry-specific taxonomies. A software application, facilitates the automation of the taxonomy generation process and allows for automatic cross-industry taxonomy updates. A standardized cross-industry taxonomy generation procedure is characterized by error reduction in cross-industry taxonomy generation.

### RELATED APPLICATIONS

This application claims priority from provisional U.S. patent application Ser. No. 61/172,183, filed on Apr. 23, 2009, titled “Method and System for Enhanced Taxonomy Generation,” which is hereby incorporated by reference in its entirety.

### BACKGROUND OF THE INVENTION

1. Field of Invention

Aspects of the present invention relate to taxonomy generation, and more specifically, to methods and systems for automated and standardized generation of taxonomies.

2. Background of the Related Art

A variety of organizations, such as government agencies, accounting firms, software providers, newswires, investors, filing agents and information intermediaries, among others, generate and use financial and/or business reports, which are known as “taxonomies.” Industry-specific taxonomies with updated industry-specific data for use by the specific industry sector are generated on a periodic basis. In a taxonomy, every element or concept is tagged or coded with information, interchangeably referred to herein as “metadata,” such as description, units, currency, and other information, so that users of the information can easily identify and understand it. Tagging or coding the information in a taxonomy also makes it computer readable and therefore more easily extracted, searched and analyzed.

Nevertheless, different taxonomies are required for different financial reporting purposes. National and/or other jurisdictions may need their own financial reporting taxonomies to reflect national/other accounting regulations. Many different organizations, including regulators, specific industries or even companies, may require specific taxonomies that cover their own business reporting needs. Moreover, depending on the industry, the output of the taxonomies may differ. Updates of a taxonomy may also be needed, for example, when there is a change in accounting standards, if there are errors in the taxonomy, and if there are missing elements or concepts that need to be included in the taxonomy. When a taxonomy needs to be updated, the traditional approach is to create a separate taxonomy for each individual industry, despite the fact that much of the information contained therein is duplicative. Creating individual taxonomies, however, is a time consuming and labor-intensive task. Furthermore, such a procedure is prone to error, in that consistency must be ensured for a variety of information concepts across different industry-specific taxonomies.

### SUMMARY OF THE INVENTION

In light of the above problems and shortcomings, there is a need in the art, therefore, for methods and systems that automate the taxonomy generation process and allow for automatic synchronized cross-industry taxonomy updates. There is a further need in the art for methods and systems that provide a standardized taxonomy generation procedure, which is easy to use and allows for relatively fast generation of taxonomies. There is a further need in the art for methods and systems that reduce the errors in taxonomy generation, while producing synchronized industry-specific taxonomies.

Aspects of the present invention solve the above problems and deficiencies, among others, by providing methods and systems that automate the taxonomy generation process and allow for automatic synchronized cross-industry taxonomy updates. In addition, various aspects present methods and systems that provide a standardized cross-industry taxonomy generation procedure, which is easy to use and allows for relatively fast generation of taxonomies. Furthermore, aspects of the present invention provide methods and systems that reduce the errors in taxonomy generation, while producing synchronized industry-specific taxonomies.

Aspects of the present invention may also include a software application, using a Graphic-User-Interface (GUI), which facilitates the automation of the taxonomy generation process and allows for automatic cross-industry taxonomy updates, which provides a standardized cross-industry taxonomy generation procedure characterized by error reduction in cross-industry taxonomy generation.

### BRIEF DESCRIPTION OF THE DRAWINGS

Various exemplary aspects of the systems and methods will be described in detail, with reference to the following figures, wherein:

FIG. 1 is a flowchart showing an exemplary publish process, in accordance with various exemplary aspects of the present invention;

FIG. 2 is a flowchart showing an exemplary serialization process, in accordance with various exemplary aspects of the present invention;

FIGS. 3A-3D present exemplary graphical user interface (“GUI”) screens, according to various aspects of the present invention;

FIG. 4 illustrates an exemplary system diagram of various hardware components and other features, for use in accordance with various exemplary aspects of the present invention; and

FIG. 5 is a block diagram of various exemplary system components, in accordance with an aspect of the present invention.

### DETAILED DESCRIPTION

Aspects of the present invention relate to the creation of a generic taxonomy model (interchangeably referred to as development technology or uber-technology), which incorporates the concepts of all industry-specific taxonomies and their related metadata, and contains an indication of which industries a specific concept or elements and its metadata pertain to. Based on the industry indication, a metadata hierarchy is created for each industry. Once an update has been made to the generic taxonomy model, updated industry-specific taxonomies may be generated based on the industry indication (i.e., the industry-specific metadata hierarchy) for each concept and metadata. In this manner, the information in the industry-specific taxonomies is automatically synchronized because all taxonomies are generated based on the updated information in the uber-technology. It should be noted that each concept may be linked to a single industry or to a number of different industries, resulting in a tree-like linking structure among the linked concepts.

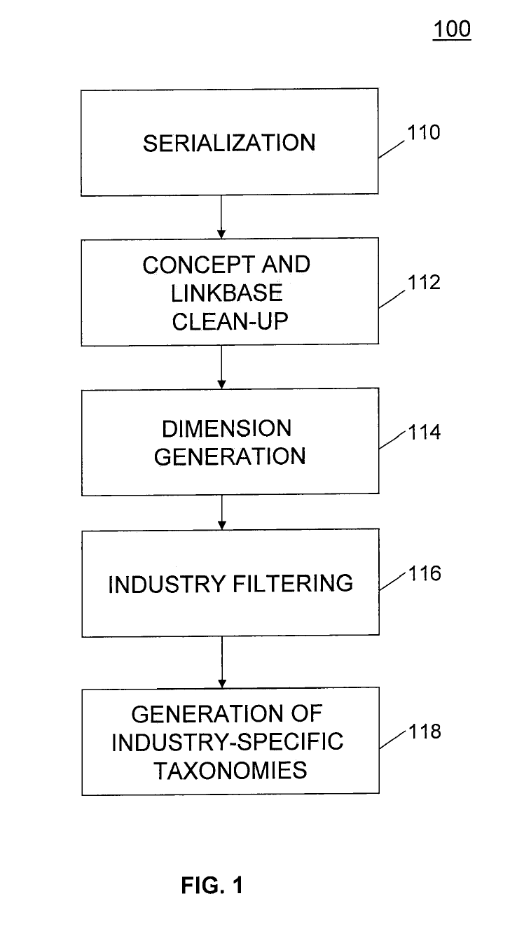

In accordance with aspects of the present invention, the process for updating the uber-taxonomy and generating industry-specific taxonomies, interchangeably referred to herein as the “publish process,” is shown in FIG. 1. The publish process performs serialization 110, concept and linkbase clean-up 112, dimension generation 114, industry filtering 116 and generation of industry-specific taxonomies 118.

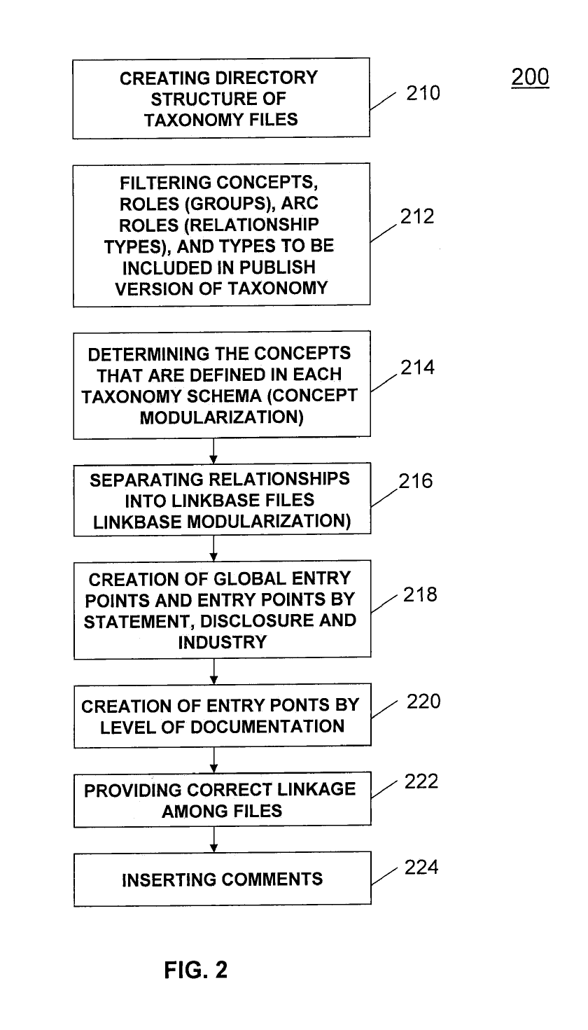

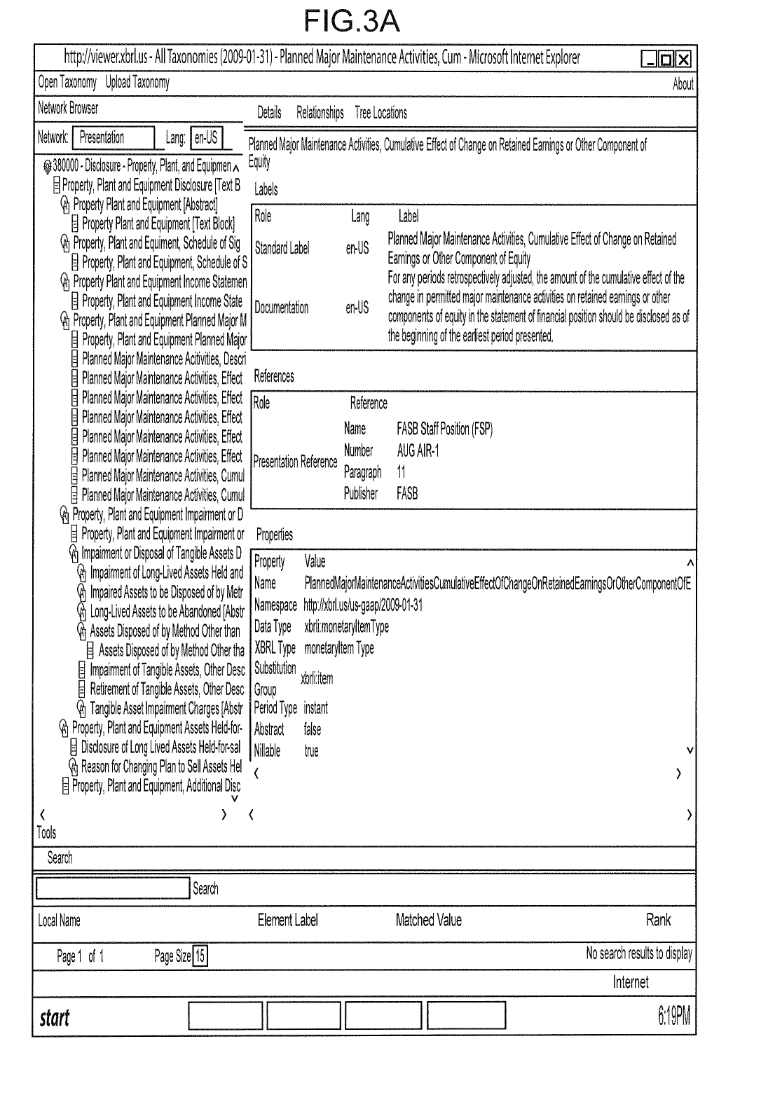

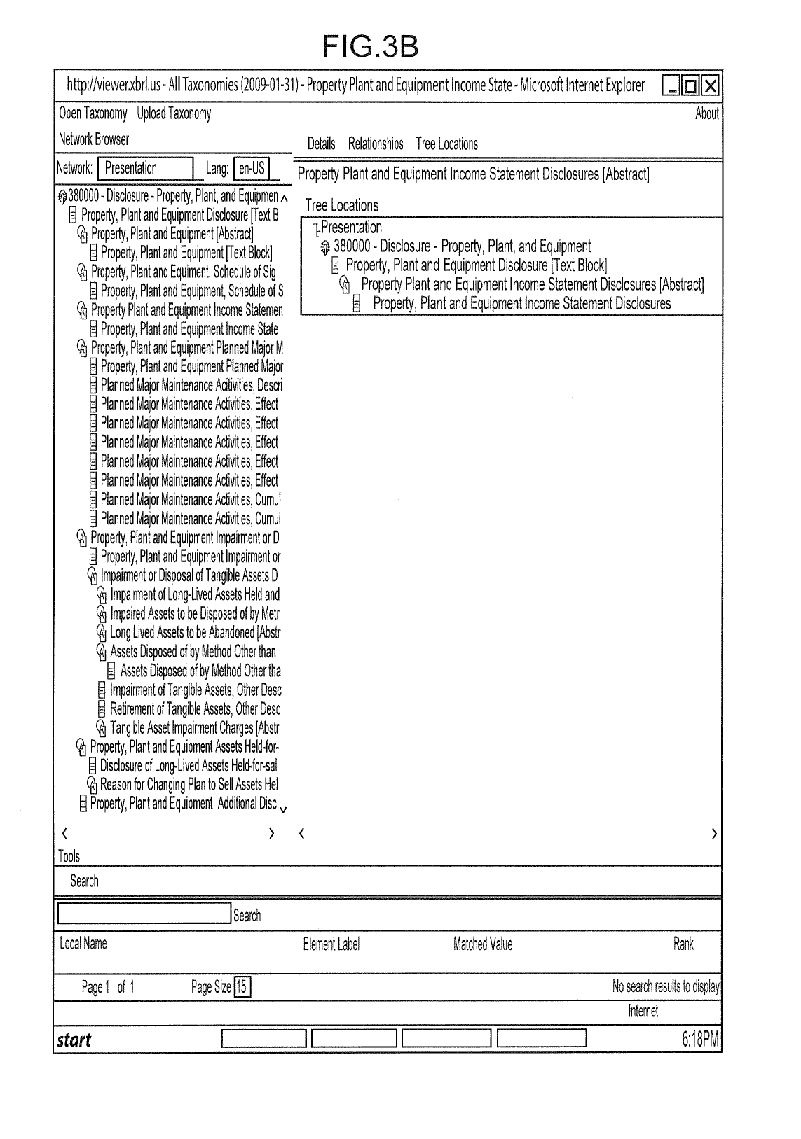

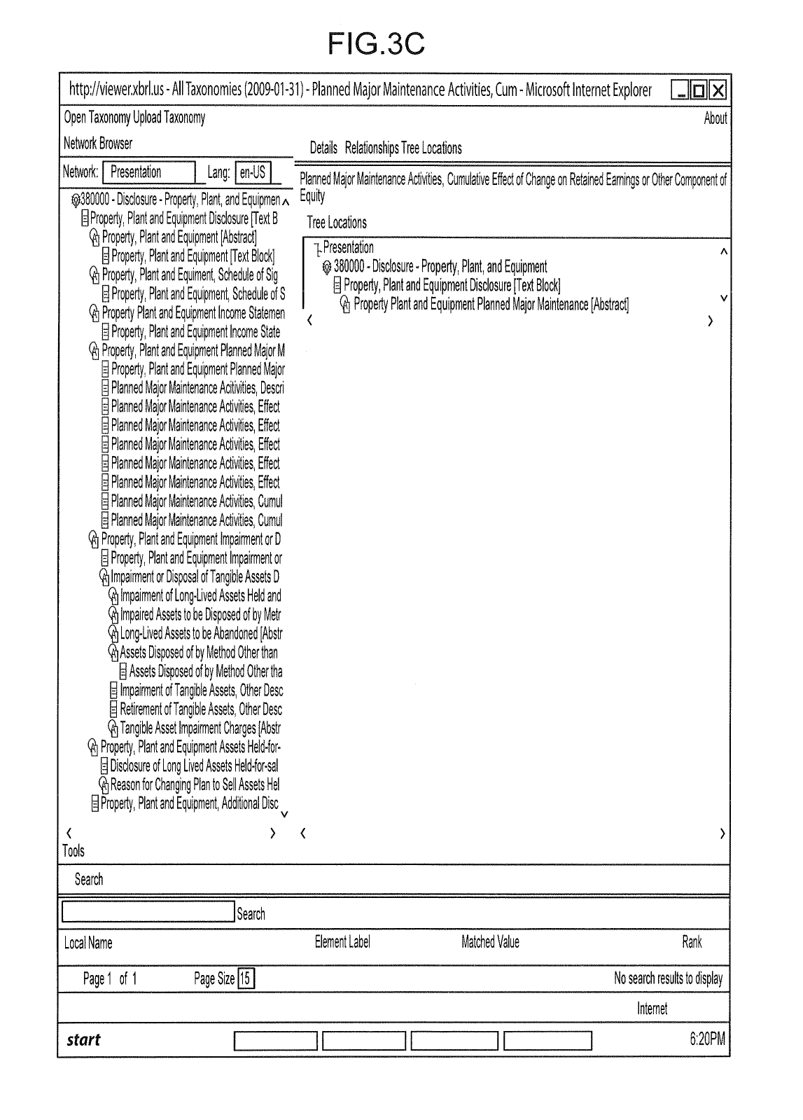

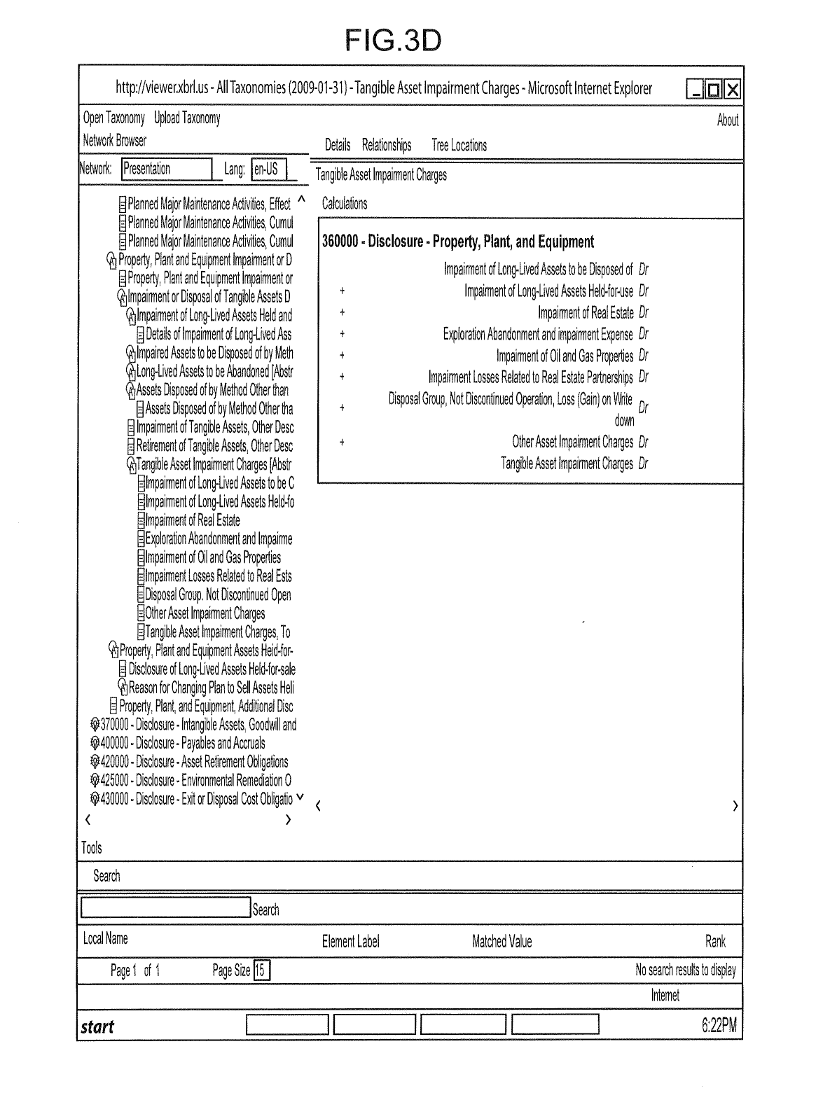

In accordance with aspects of the present invention, the process of serialization is shown in FIG. 2. Serialization is the process of creating the physical files of the taxonomy. In the process of taxonomy creation and maintenance, a taxonomy may be stored in two forms, for example. The first form may be a development version of the taxonomy, and the second may be the published version of the taxonomy. For purposes of illustration only, a taxonomy stored in two forms will be described. However, one of ordinary skill in the art will recognize that a taxonomy stored in a single form may likewise be used.

The development or uber-version of a taxonomy may be maintained in a haphazard set of files, for example. In accordance with aspects of the present invention, the publish process may ignore the physical file structure of the development version of the taxonomy and may generate a predetermined physical file structure, which permits the tools that are used to update the development version of the taxonomy to write physical files in any manner. The physical file structure is consistently created through the publish process.

The physical file structure determines how the taxonomy is modularized. The modularization allows taxonomy users to control what portions of the taxonomy they use. The serialization process includes creating the directory structure of the taxonomy files 210, filtering concepts, roles (groups), arc roles (relationship types), and types that will be included in the publish version of the taxonomy 212, determining which concepts are defined in which taxonomy schema files (concept modularization) 214, separating relationships into linkbase files (linkbase modularization) 216, creating global entry points and entry points by statement, disclosure and industry 218, creating entry points by level of documentation 220, providing correct linkage among files (i.e., import, schemaRef and linkbaseRef) 222, and, inserting comments in each file (e.g., copyright and legal notice) 224.

Referring again to FIG. 1, the publish process performs concept and linkbase cleanup 112. For example, all concepts have a name and identification (“id”) attribute. In accordance with aspects of the present invention, the publish process may ensure that the id of every concept is derived from the concept name, which would provide consistency between the concept name and id in the publish version of the taxonomy. Further, the publish process may ensure that certain types of concepts have particular attributes. For example, all “Table” and “Axis” concepts should always have an “abstract” attribute with the value of “true.” In accordance with aspects of the present invention, the publish process may create these concepts with this attribute regardless of whether the concept is abstract in the development version of the taxonomy.

In accordance with aspects of the present invention, some concepts have a predefined label. This occurs for “Roll Forward” and “Line Items” concepts. The publish process may create these type of concepts with a predefined text.

In accordance with aspects of the present invention, the publish process filters for only publishable label types (i.e., standard, period start, period end, total, documentation). This may likewise be performed for references. The publish process may clean up label text (removing leading and trailing spaces) and may ensure consistent capitalization of the language identifier (“en-US”).

In accordance with aspects of the present invention, the publish process may filter only publishable concept-to-concept relationships. The process may also renumber the order of relationships with a consistent order step.

Referring again to FIG. 1, dimension generation is performed 114. In accordance with aspects of the present invention, the development version of the taxonomy may not explicitly define dimensional aspects of the taxonomy. Instead, taxonomists may identify the dimensional aspects of the taxonomy by using keywords in the concept labels. These keywords may include “Table”, “Axis”, “Domain”, “Member” and “Line Items.” In accordance with aspects of the present invention, the publish process may create the definition linkbase needed to create dimensions in the taxonomy based on these keywords.

In accordance with aspects of the present invention, industry filtering is performed 116. Different industries have different versions of financial statements. Often, these different versions are structurally the same except for some specific concepts that may appear in one industry and not another. In accordance with aspects of the present invention, the taxonomy that is published contains a set of statement presentations for each industry.

In order to keep the common parts of these statements between synchronized industries and to simplify the maintenance of the statements, the only one statement structure for a common set of industries may be maintained. These can include concepts that only apply to a subset of the industries. For each concept, an identification is performed as to which industries are valid. In accordance with aspects of the present invention, the publish process may create separate presentations for each industry with the inappropriate concepts filtered out of the structure based on the associations.

Industry-specific taxonomies are generated 118 and outputted on an output device.

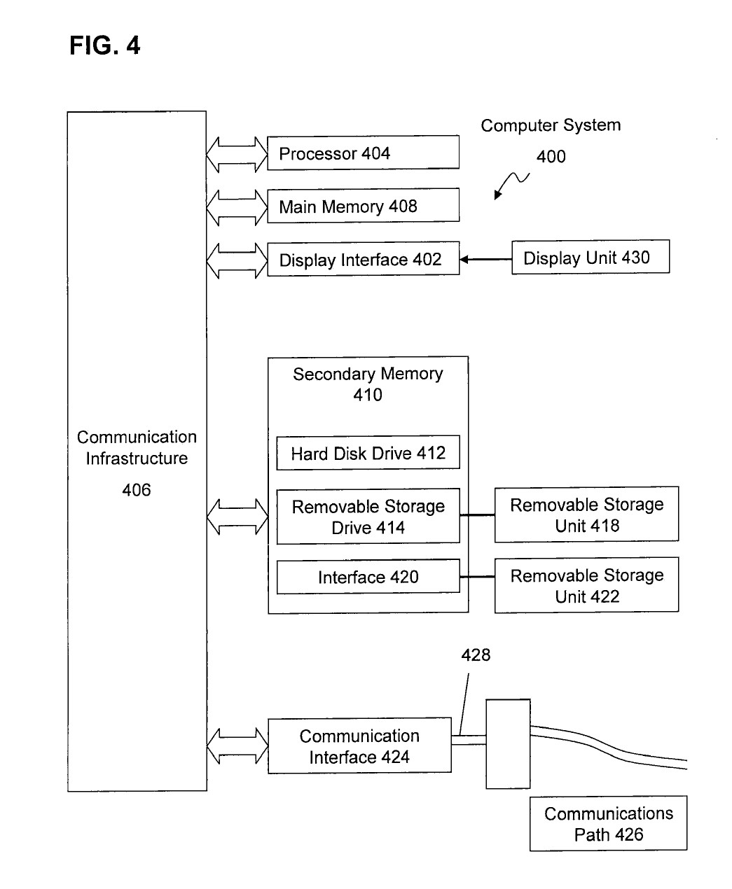

Aspects of the present invention may be implemented using hardware, software, or a combination thereof and may be implemented in one or more computer systems or other processing systems. In one aspect, the invention is directed toward one or more computer systems capable of carrying out the functionality described herein. An example of such a computer system 400 is shown in FIG. 4.

Computer system 400 includes one or more processors, such as processor 404. The processor 404 is connected to a communication infrastructure 406 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 400 can include a display interface 402 that forwards graphics, text, and other data from the communication infrastructure 406 (or from a frame buffer not shown) for display on a display unit 430. Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well-known manner. Removable storage unit 418, represents a floppy disk, magnetic tape, optical disk, etc., which is read by and written to removable storage drive 414. As will be appreciated, the removable storage unit 418 includes a computer usable storage medium having stored therein computer software and/or data.

In alternative aspects, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428, which may be electronic, electromagnetic, optical or other signals capable of being received by communications interface 424. These signals 428 are provided to communications interface 424 via a communications path (e.g., channel) 426. This path 426 carries signals 428 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 480, a hard disk installed in hard disk drive 470, and signals 428. These computer program products provide software to the computer system 400. The invention is directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 410 to perform the features of the present invention. Accordingly, such computer programs represent controllers of the computer system 400.

In an aspect where the invention is implemented using software, the software may be stored in a computer program product and loaded into computer system 400 using removable storage drive 414, hard drive 412, or communications interface 420. The control logic (software), when executed by the processor 404, causes the processor 404 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

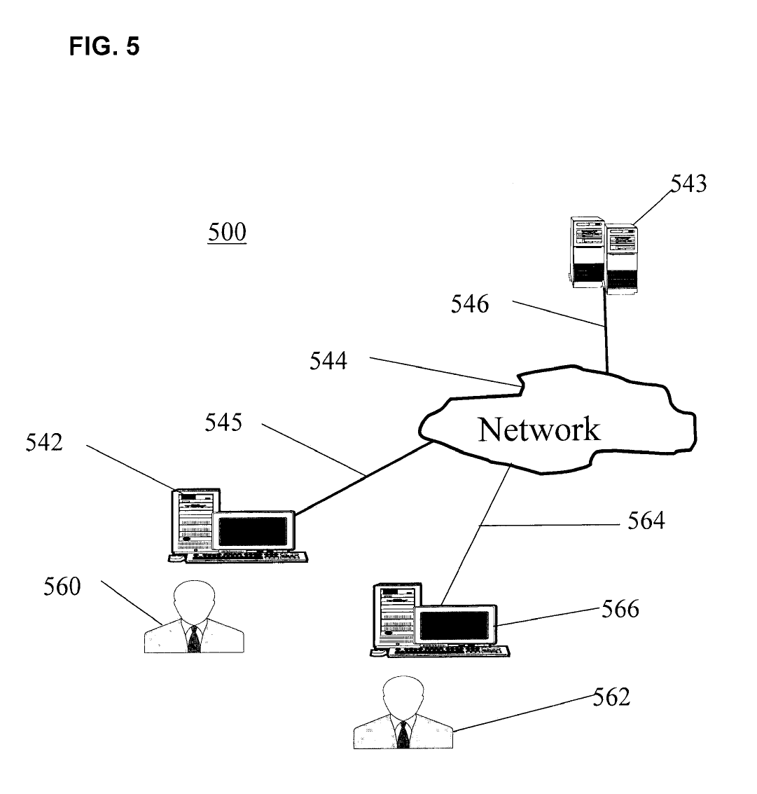

FIG. 5 shows a communication system 500 usable in accordance with the present invention. The communication system 500 includes one or more accessors 560, 562 (also referred to interchangeably herein as one or more “users”) and one or more terminals 542, 566. In one aspect, data for use in accordance with the present invention is, for example, input and/or accessed by accessors 560, 564 via terminals 542, 566, such as personal computers (PCs), minicomputers, mainframe computers, microcomputers, telephonic devices, or wireless devices, such as personal digital assistants (“PDAs”) or a hand-held wireless devices coupled to a server 543, such as a PC, minicomputer, mainframe computer, microcomputer, or other device having a processor and a repository for data and/or connection to a repository for data, via, for example, a network 544, such as the Internet or an intranet, and couplings 545, 546, 564. The couplings 545, 546, 564 include, for example, wired, wireless, or fiberoptic links. In another aspect, the method and system of the present invention operate in a stand-alone environment, such as on a single terminal.

While the present invention has been described in conjunction with the various aspects outlined above, various alternatives, modifications, variations, improvements, and/or substantial equivalents, whether known or may be presently unforeseen, may become apparent to those having at least ordinary skill in the art. Accordingly, the exemplary aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A method for creating a generic taxonomy model for a plurality of industries, each industry having an industry-specific taxonomy, each taxonomy having a concept and related metadata, the method comprising:
building the generic taxonomy model via the processor, the model comprising concepts and related metadata of the plurality of industries;
creating a metadata hierarchy for each of the plurality of industries;
generating industry-specific taxonomies based on the metadata hierarchy of each of the plurality of industries; and
updating the industry-specific taxonomies for the plurality of industries when the generic taxonomy model is updated;
wherein information contained in the industry-specific taxonomies is automatically synchronized with the updated generic taxonomy model.

2. The method of claim 1, wherein creating the metadata hierarchy is performed based on industry indication.

3. The method of claim 1, wherein each of the industry-specific taxonomies is stored in at least one of an updated version and a published version, each version having respective physical files.

4. The method of claim 1, wherein updating industry-specific taxonomies is based on industry indication for each concept and metadata.

5. The method of claim 4, wherein the industry indication comprises industry-specific metadata hierarchy.

6. The method of claim 1, wherein the concept is related to a plurality of industries.

7. The method of claim 1, wherein generating the industry-specific taxonomies comprises:
serializing physical files;
correlating concepts and respective attributes;
generating a dimension of one or more of the taxonomies; and
filtering industries by generating a set of statement presentations for each industry.

8. The method of claim 7, wherein serializing the physical files comprises:
creating the physical files for each taxonomy;
creating directory structure of the physical files of each taxonomy;
filtering concepts, groups and relationship types that are included in each taxonomy;
determining the concepts corresponding to each of a plurality of taxonomy schema files;
separating relationship types into linkbase files;
creating global entry points by at least one of statement, disclosure, industry, and level of documentation; and
providing correct linkage among the physical files.

9. The method of claim 8, further comprising:
inserting comments in one or more of the physical files.

10. The method of claim 7, wherein one or more of the concepts are correlated to specific attributes.

11. The method of claim 7, wherein the concepts and their respective attributes are consistent.

12. The method of claim 7, wherein one or more of the concepts have predefined attributes.

13. The method of claim 7, wherein the dimension comprises one of table, Axis, Domain, Member, and Line Item.

14. A system for creating a generic taxonomy model for a plurality of industries, each industry having an industry-specific taxonomy, each taxonomy having a concept and related metadata, the system comprising:
a building module for building the generic taxonomy model via the processor, the model comprising concepts and related metadata of the plurality of industries;
a creating module for creating a metadata hierarchy for each of the plurality of industries;
a generating module for generating industry-specific taxonomies based on the metadata hierarchy of each of the plurality of industries; and
an updating module for updating the industry-specific taxonomies for the plurality of industries when the generic taxonomy model is updated;
wherein information contained in the industry-specific taxonomies is automatically synchronized with the updated generic taxonomy model.

15. A system for creating a generic taxonomy model for a plurality of industries, each industry having an industry-specific taxonomy, each taxonomy having a concept and related metadata, the system comprising:
a processor;
a user interface functioning via the processor; and
a repository accessible by the processor; wherein
the generic taxonomy model is built, the model comprising concepts and related metadata of the plurality of industries;
a metadata hierarchy for each of the plurality of industries is created;
industry-specific taxonomies are generated based on the metadata hierarchy of each of the plurality of industries; and
the industry-specific taxonomies for the plurality of industries are updated when the generic taxonomy model is updated;
wherein information contained in the industry-specific taxonomies is automatically synchronized with the updated generic taxonomy model.

16. The system of claim 15, wherein in order for the industry-specific taxonomies to be generated via the processor:
physical files are serialized;
concepts and respective attributes are correlated;
a dimension of one or more of the taxonomies is generated; and
industries are filtering by the creation of a set of statement presentations for each industry.

17. The system of claim 16, wherein in order for the physical files to be serialized via the processor:
the physical files are created for each taxonomy;
a directory structure of the physical files is created for each taxonomy;
concepts, groups and relationship types that are included in each taxonomy are filtered;
the concepts corresponding to each of a plurality of taxonomy schema files are determined;
relationship types are separated into linkbase files;
global entry points are created by at least one of statement, disclosure, industry, and level of documentation; and
correct linkage is provided among the physical files.

18. The system of claim 17, wherein one or more of the concepts are correlated to specific attributes.

19. The system of claim 17, wherein the concepts and their respective attributes are consistent.

20. A computer program product comprising a computer usable medium having control logic stored therein for causing a computer to create a generic taxonomy model for a plurality of industries, each industry having an industry-specific taxonomy, each taxonomy having a concept and related metadata, the control logic comprising:
computer readable program code means for building the generic taxonomy model via the processor, the model comprising concepts and related metadata of the plurality of industries;
computer readable program code means for creating a metadata hierarchy for each of the plurality of industries;
computer readable program code means for generating industry-specific taxonomies based on the metadata hierarchy of each of the plurality of industries; and
computer readable program code means for updating the industry-specific taxonomies for the plurality of industries when the generic taxonomy model is updated;
wherein information contained in the industry-specific taxonomies is automatically synchronized with the updated generic taxonomy model.
